(19) United States
(12) Patent Application Publication
(10) Pub. No.: US 2025/0173820 A1
(43) Pub. Date: May 29, 2025

(54) METHOD, DEVICE AND SYSTEM FOR PROCESSING SPATIAL DATA

(71) Applicant: GRABTAXI HOLDINGS PTE. LTD., Singapore (SG)

(72) Inventors: Yuxiang PENG, Beijing (CN); Haonan DONG, Beijing (CN); Bo HU, Beijing (CN)

(21) Appl. No.: 18/842,456

(22) PCT Filed: Apr. 13, 2023
(86) PCT No.: PCT/SG2023/050250

§ 371 Date: Aug. 29, 2024

(30) Foreign Application Priority Data
May 11, 2022 (SG) 10202204935R

(51) Int. Cl. G06T 3/4038

(52) U.S. Cl. CPC G06T 3/4038

(57) ABSTRACT

Aspects concern a method for processing spatial data comprising the steps of: receiving a spatial data file from a spatial data source; generating a first tileset associated with the spatial data file, the first tileset comprising a plurality of tiles and corresponding identifiers; comparing the identifier of each of the plurality of tiles in the first tileset with an identifier of each tile in a second tileset to identify at least one duplicate; and merging the tiles identified to be duplicate tiles.

### TECHNICAL FIELD

Various aspects of this disclosure relate to methods, devices and systems for processing spatial data.

### BACKGROUND

Spatial data, such as satellite image data, are increasingly used for various purposes and applications such as vehicular navigation, nature exploration, and weather forecasting.

Spatial data such as geographical maps may be processed, rendered and visualized on a web or Internet browser using a method known as tiling. A tiled geographical map may be displayed by seamlessly joining a plurality of individually requested images. These individually requested images may also be referred as raster tiles.

Current methods for processing spatial data may be inadequate to cope with the exponentially increasing data sets, which pose challenges in terms of storage, bandwidth, and maintenance. In addition, the processing of spatial data may result in huge number of stored duplicates. Accordingly, there exists a need for improved processing and maintenance of spatial data.

### SUMMARY

The technical solution seeks to provide a method, device and/or system for processing spatial data, such as standard satellite imagery. In some embodiments, the process includes tiling, updating storage and long-term maintenance to facilitate creation of one or more self-hosted satellite map tile services, where a user can request area-specific geographical map tiles on demand, stitch and render them. Output of the method, device and/or system, in the form of map tiles, may be utilized by a navigation system installed in a vehicle, such as a car, for access by a user via one or more user interfaces.

According with an aspect of the disclosure there is provided a method for processing spatial data comprising the steps of: receiving a spatial data file from a spatial data source; generating a first tileset associated with the spatial data file, the first tileset comprising a plurality of tiles and corresponding identifiers; comparing the identifier of each of the plurality of tiles in the first tileset with an identifier of each tile in a second tileset to identify at least one duplicate; and merging the tiles identified to be duplicate tiles.

In some embodiments, each generated identifier may comprise a zoom level data and a location data associated with the corresponding tile.

In some embodiments, the method comprises a step of generating a duplicate indicator and appending the duplicate indicator to the identifier, the duplicate indicator associated with the number of duplicate tiles in the first tileset and the second tileset.

In some embodiments, the step of generating the first tileset comprises combining a plurality of generated tiles associated with a higher zoom level to generate a tile associated with a lower zoom level.

In some embodiments, the method further comprises a step of packaging the merged tiles into a file format for storing tileset.

In some embodiments, the merged tiles are stored in a specified directory.

In some embodiments, the step of merging the tiles comprises overlaying at least one duplicate tile over another duplicate tile.

According with another aspect of the disclosure there is provided a device for processing spatial data comprising an input module configured to receive a spatial data file and a second tileset; a tiling module configured to generate a first tileset associated with the spatial data file, the first tileset comprises a plurality of tiles and corresponding identifiers; an update module configured to compare the identifier of each of the plurality of tiles within the first tileset with an identifier of each tile in a second tileset to identify at least one duplicate; and merge the tiles identified to be duplicate tiles.

In some embodiments, each generated identifier comprises a zoom level data and a location data associated with the corresponding tile.

In some embodiments, the update module is configured to generate and append a duplicate indicator to the zoom level data and the location data, the duplicate indicator associated with the number of duplicate tiles in the first tileset and the second tileset.

In some embodiments, the tiling module is configured to generate the first tileset by combining a plurality of generated tiles associated with a higher zoom level to generate a tile associated with a lower zoom level.

In some embodiments, the update module is configured to package the merged tiles into a file format for storing tileset.

In some embodiments, the update module is configured to store the merged tiles into a specific directory.

In some embodiments, the update module is configured to merge the duplicate tiles by overlaying at least one duplicate tile over another duplicate tile.

According to another aspect of the disclosure there is a system for processing spatial data comprising the device as described, and a storage module, wherein the merged tiles are sent to the storage module.

In some embodiments, the system further comprises a Web Map Tile Service (WMTS) service, wherein the storage module comprise an interface to allow access by a Web Map Tile Service (WMTS).

In some embodiments, the system further comprises a vehicle navigation system configured to access the WMTS for rendering map tiles on demand.

According to another aspect of the disclosure there is provided a system for processing spatial data comprising a master node arranged in data or signal communication with a plurality of slave nodes, the master node comprising a task scheduler to assign at least one task to each of the plurality of slave nodes; a first slave node configured to generate a first tileset associated with a first spatial data file, the first tileset comprising a plurality of tiles and corresponding identifiers; a second slave node configured to generate a second tileset associated with a second spatial data file, the second tileset comprising a plurality of tiles and corresponding identifiers; a processing module configured to compare the identifiers of each of the plurality of tiles within the first tileset with the identifiers of each tile in the second tileset to identify at least one duplicate, and a third slave node configured to merge the tiles identified to be duplicated tiles.

In some embodiments, each generated identifier comprises a zoom level data and a location data associated with the corresponding tile.

In some embodiments, the update module is configured to generate and append a duplicate indicator to the zoom level data and the location data, the duplicate indicator associated with the number of duplicate tiles in the first tileset and the second tileset.

In some embodiments, the system further comprises a storage module arranged in data or signal communication with at least one of the first slave node, the second slave node and the third slave node.

In some embodiments, the system further comprises a pre-processing module to obtain a batch of spatial data and split the batch of spatial data into at least the first spatial data file and the second spatial data file.

In some embodiments, the storage module is configured to identify from the batch of spatial data, at least one spatial data file associated with a specific file format, such that spatial data files associated with the specific file format are configured to be sent to the third slave node bypassing the pre-processing module.

In another aspect of the disclosure, there is provided a non-transitory computer-readable storage medium comprising instructions, which, when executed by one or more processors, cause the execution of the method for processing spatial data according to any one according to any one of the method embodiments described above.

In another aspect of the disclosure, there is provided a data processing device configured to perform the method according to any one of the method embodiments described above.

In another aspect of the disclosure, there is provided a computer executable code comprising instructions for processing spatial data according to any one of the method embodiments described above.

### BRIEF DESCRIPTION OF THE DRAWINGS

The disclosure will be better understood with reference to the detailed description when considered in conjunction with the non-limiting examples and the accompanying drawings, in which:

FIG. 1 is a flowchart associated with methods for processing spatial data in accordance with various embodiments;

FIGS. 2A to 2C illustrate a concept of tiles and zoom levels associated with a tiling process of spatial data files in the context of the present disclosure;

FIG. 3 shows a system architecture comprising a tile module, a storage module and a Web Map Tile Service (WMTS) in accordance with various embodiments;

FIG. 4 shows a flowchart associated with a method for splitting and merging tiles;

FIG. 5 shows a distributed system for processing spatial data in accordance with various embodiments; and

FIG. 6 shows a schematic illustration of a processor for processing spatial data in accordance with some embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the enclosure systems, devices or methods are analogously valid for the other systems, devices or methods. Similarly, embodiments described in the context of a system are analogously valid for a device or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

As used herein, the term “data” may be understood to include information in any suitable analog or digital form, for example, provided as a file, a portion of a file, a set of files, a signal or stream, a portion of a signal or stream, a set of signals or streams, and the like. The term data, however, is not limited to the aforementioned examples and may take various forms and represent any information as understood in the art.

As used herein, the term “spatial data” refers to data in various formats that is associated with one or more geographical locations or areas. Non-limiting examples of spatial data include satellite images, georeferenced maps in two-dimensional or three-dimensional form. Such spatial data may be stored in various file formats with or without metadata. Non-limiting examples of file formats include Geotiff, .png and .jpg file formats.

As used herein, the term “metadata” broadly refers to data in various data format that provides information about a content, excluding the content. For example, a metadata associated with an image may include information such as image source, image capturing device, actual location/coordinates in space, and representation of each pixel in an image. Metadata may be added to an existing metadata. In an example, a metadata may be expressed as an identifier or key in a form Z/X/Y, wherein Z represents a map tile zoom level, X and Y represent the X and Y coordinates of the image on the plane axis respectively. Further information may be tagged or appended to a metadata after processing or analysis to indicate a state, an attribute, and/or a parameter of the metadata relative to other metadata.

As used herein, the term “update” broadly includes any process that reduces at least one of processing time and/or data duplicity without comprising on data integrity. Examples of update operation may include a merge operation, an overlay operation, a partial rewrite operation, exception catching, log tracking, version control data rollback capabilities, and one or more combinations of the aforementioned.

As used herein, the term “module” refers to, or forms part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor. A single module or a combination of modules may be regarded as a device.

As used herein, the term “node” refers to any computing device that has processing and communication capabilities. Non-limiting examples of nodes include a computer, a mobile smart phone, a computer server.

As used herein, the term “associate”, “associated”, “associate”, and “associating” indicate a defined relationship (or cross-reference) between two items. For instance, a tileset can be associated with a spatial data file, indicating that the tileset may be derived, computed, and/or processed using the spatial data file as a source or reference. The tileset may be a subset or of the spatial data file or may include additional information such as metadata.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

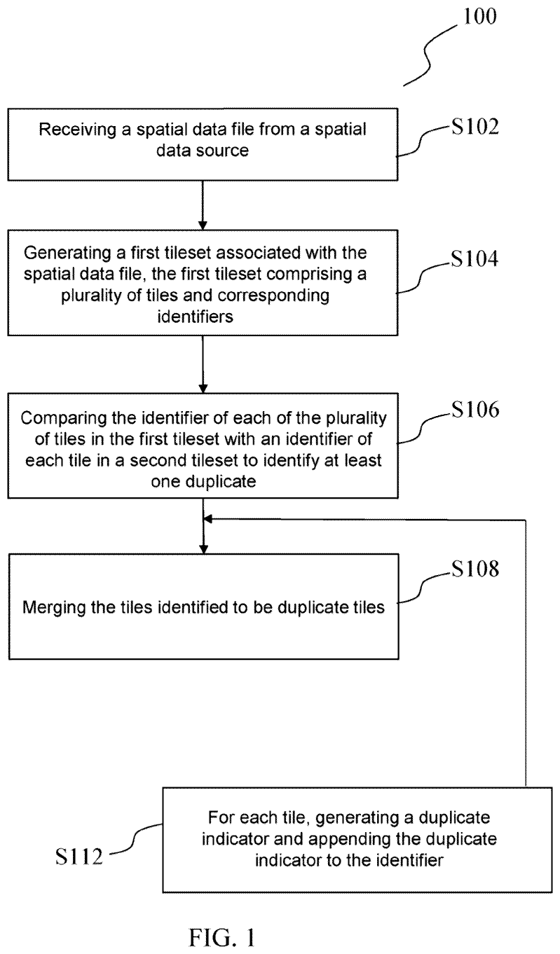

According with an aspect of the disclosure and referring to FIG. 1, there is a method 100 for processing spatial data comprising the steps of: receiving a spatial data file from a spatial data source (step S102); generating a first tileset associated with the spatial data file, the first tileset comprising a plurality of tiles and corresponding identifiers (step S104); comparing the identifier of each of the plurality of tiles in the first tileset with an identifier of each tile in a second tileset to identify at least one duplicate (step S106); and merging the tiles identified to be duplicate tiles (step S108).

The spatial data file may be a satellite image having a file format such as Geotiff and stored on a storage module configured for access by a WMTS service. In some embodiments, the storage module may be configured to provide high persistence, high availability and high security for the storage of satellite imagery tilesets. For example, such storage module may be hosted by a cloud service, and/or may be implemented as distributed databases shared among different nodes, such as a blockchain. In some embodiments, the storage module may be periodically arranged to receive spatial data via a job scheduler.

The storage module may be configured to support content delivery network (CDN) acceleration for the satellite imagery tilesets. The CDN may include a geographically distributed group of servers which work together to provide relatively fast delivery of Internet content.

In step S102, the spatial data file may be obtained from the storage module.

In step S104, the generation of the first tileset may include the generation of raster images and corresponding identifiers. The corresponding identifiers may be appended to pre-existing metadata that accompanies the source spatial data file, or may be newly generated if the source spatial data file does not include have any metadata. Examples of pre-existing metadata may include at least one of the following information on imagery source, image capturing device, actual location in space, and representation of each pixel in an image. The generated identifier may be expressed in a form Z/X/Y, wherein Z represents the zoom level, X and Y represent a range of X and Y coordinates of the image on a plane axis respectively. For clarity purpose, the generated identifier may be referred to as a “key” from henceforth.

In step S106, the second tileset may be associated with another spatial data file, which may include previously processed tiled images already stored in the storage module. The comparison of the identifier to identify one or more duplicates may include comparing the same Z/X/Y key. For example, two tilesets—the first tileset and the second tileset generated from two spatial data files, may both include a key indicating “Z1/X1/Y1”. This may correspond to two satellite images (one image from the first tileset and one image from the second tileset) associated with the same location or approximately the same location.

In step S108, the merging of tiles associated with the duplicated tiles based on the identifier may include an image processing step, such as an overlay operation, to combine or merge the duplicate tiles. It is appreciable that the two duplicate tiles associated with key “Image-Z1/X1/Y1, (1, 1)” in the earlier example will be combined. The new combined tile may replace the original duplicate tiles, and the original duplicate tiles may be removed or deleted, hence reducing memory resources.

In some embodiments, the key are expressed and stored as integers, wherein zoom level Z is an integer value ranging from 0 to 22, and X and Y represent a particular section of a divided map.

Using a world map as an example of a spatial data to be processed, Z/X/Y=0/0/0 corresponds to zoom level 0, and as Zoom level 0 does not comprise any divided tile, there is only one spatial data file 0/0/0 associated with zoom level 0.

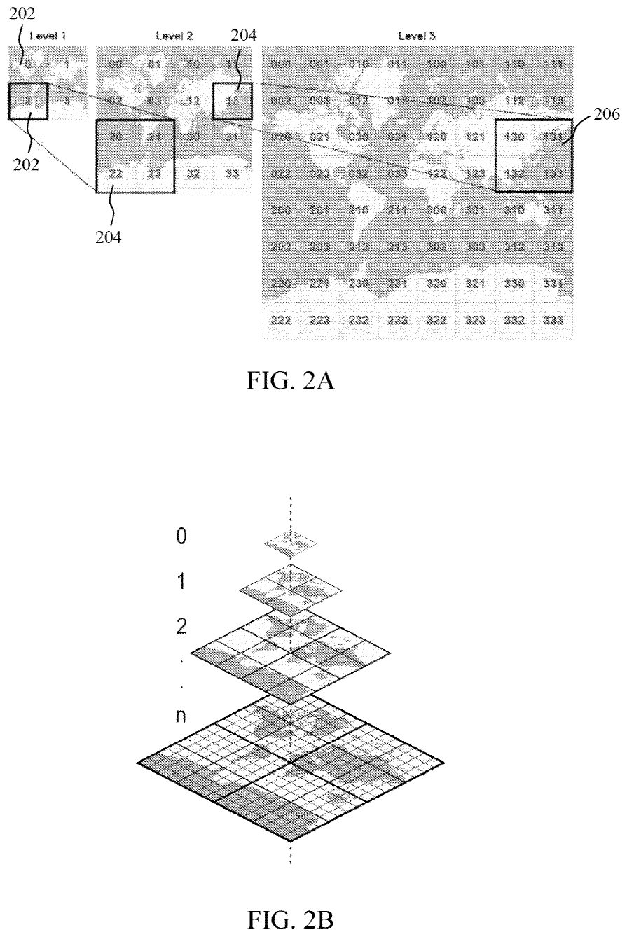

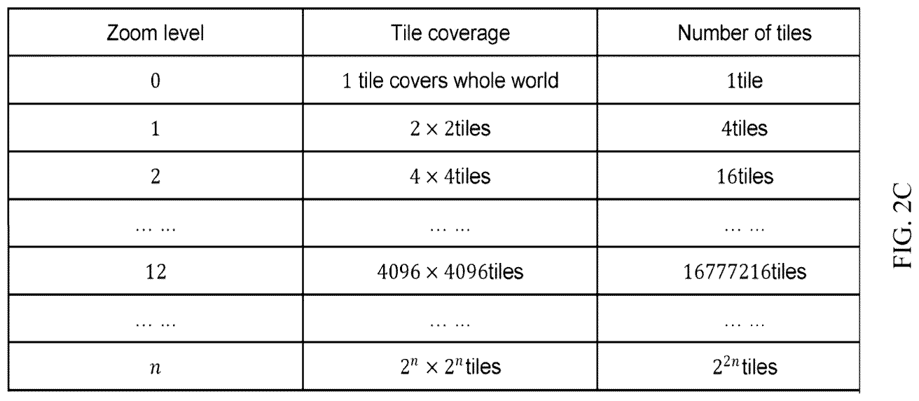

At Zoom level 1, the world map is divided into four equal parts as shown in FIG. 2A, which corresponds to four keys Z/X/Y=1/0/0, 1/0/1, 1/1/0, 1/1/1, each key correspond to a map tile 202.

The key 1/0/0 may correspond to a map tile in an upper left corner. In that case, key 1/0/0 corresponds to a geographic interval that takes values from −180 to 0 (half of −180 to 180) for longitude and 0 to 90 (half of −90 to 90) for latitude. The key 1/0/1 may correspond to a map tile in an upper right corner has the same latitude range as 1/0/0 (0 to 90) and a longitude range of 0 to 180 (half of −180 to 180). The key 1/1/0 may correspond to a map tile in the lower left corner which has the same longitude range as 1/0/0 ( −180 to 0) and a latitude range of −90 to 0. The key 1/1/1 may correspond to a map tile in the lower right corner which has a longitude range of 0 to 180 and a latitude range of −90 to 0.

Each of the four tile images at Z=1 can be divided into four equal parts as before, making a total of 16 keys at Z=2, each key corresponding a map tile 204 as shown in FIG. 2A.

In some embodiments, the step of comparing in step S106 may include the step of generating a duplicate indicator in the first tileset and the second tileset and appending the duplicate indicator to the identifier (step S112). The duplicate indicator may be in the form of a tag, and may be appended to the generated key. For example, in the example where the first tileset and the second tileset both contain the tile associated with key Z1/X1/Y1, the duplicate indicator (1,1) may be appended to the entry to form a modified identifier “Image-Z1/X1/Y1,(1, 1)”, the tag (1,1) associated with two duplicate entries. Another tile from the first or second tileset may include metadata indicating “Z3/X3/Y3”, with generated tag (1) appended to the identifier, i.e.—“Image-Z3/X3/Y3, (1)”. The tag (1, 1) means there are two images with the same metadata in the generated tilesets, the tag (1) means there is only one image with this metadata in the tilesets. In general, whenever an additional duplicate tile is found, the an additional (1) is added to the tag, i.e. (1, 1, 1) for three duplicate tiles, (1, 1, 1, 1) for four duplicate tiles and so on. It is envisaged that other forms of tagging are contemplated.

FIG. 2A to FIG. 2C illustrate an example of forming a plurality of tiles based on spatial data in the form of a world map. In some embodiments, the plurality of tiles may comprise square images, which may be in the form of bitmap data format that comprise a map displayed in a grid-like arrangement. The tiles may be generated according to a plurality of zoom levels, each zoom level representing how large or small the contents of a map appear in a map view. At zoom level 0, the entire world fits on a single tile.

As shown in FIG. 2A, the single tile at zoom level 0 is split into four tiles 202 numbered from 0 to 3 at zoom level 1 for the global coverage. Each subsequent zoom level quad divides the tiles of the previous one, creating a grid comprising 2^{zoom}×2^{zoom} number of tiles. The geographical scope remains the same from the bottom to the top of the tile pyramid as shown in FIG. 2B. It is appreciable that the number of tiles is fixed for each zoom level, that is, zoom level 2 comprises sixteen tiles 204, zoom level 3 comprises sixty-four tiles 206 and the number of tiles at a next higher zoom level can be generalized or predicted by multiplying the number of tiles at the current zoom level by four as illustrated in FIG. 2C.

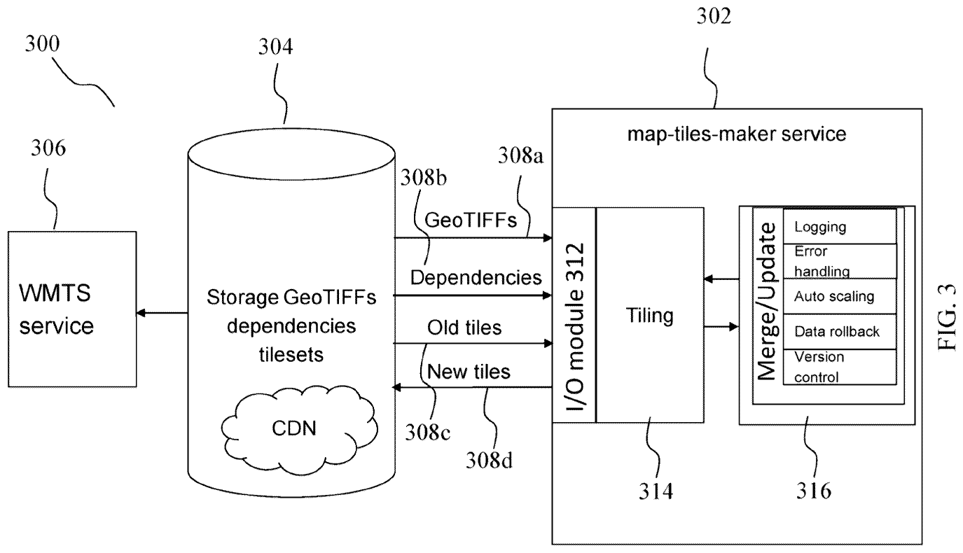

FIG. 3A is a system architecture of a system 300 for processing spatial data comprising a tile generator device (also referred to as a map tiles maker) 302, a spatial data storage 304 and a spatial data rendering service 306. Each of the aforementioned components may be a standalone, or various integration between the components may be contemplated. For example, in some embodiments, the map tiles maker device 302 may be combined with the spatial data storage 304 to form an integrated device.

In some embodiments, the map tiles maker device 302 may be a computing device such as a desktop computer or a laptop computer arranged in data and/or signal communication with the spatial data storage 304. Device 302 may include input/output module 312 configured to receive spatial data and other input data from the spatial data storage 304, and return processed spatial tiles to the spatial data storage 304. The spatial data storage 304 may be the storage module as described. The spatial data may be in the form of data file format Geotiff. The Geotiff files 308a from the spatial data storage module 304 for processing, and may in some embodiments receive dependencies 308b, current (old) tiles 308c, from the spatial data storage module 304. The output of the device 302 send the updated tiles 308d to the spatial data storage module 304 after processing. In some embodiments, the dependencies 308b may include importation of software libraries, such as a Geospatial Data Abstraction Library (GDAL) and an image processing library. The dependency files may be of a binary format compiled based on the operating system for Geotiff tiling processing.

It is contemplated that the map tile maker device 302 may implement and execute the method 100. The map tile maker device 302 may include a tiling module 314 and an update module 316. The step of converting the spatial data 308a into a plurality of tiles may be implemented by the tiling module 314, which also generates a corresponding key for each tile if necessary. The update module 316 may be configured to compare each key of the plurality of tiles with old tiles 308c in the data storage module 304 to identify duplicates and generate corresponding duplicate indicators in the form of tags to be appended to each key. If duplicates are found, the update module 316 operates to merge the tiles associated with the duplicated identifiers to form updated tiles 308d. The update module 316 may also implement the merging step S108. In some embodiments, the update module 316 may include sub modules such as, but not limited to, data loggers, error handlers, auto scalers, data rollback, and version control. The updated tiles 308d may be used to replace one or more existing tiles in the spatial data storage module 304.

It is contemplated that the tilesets may generated asynchronously and may not affect the operation of the spatial data storage module 304. As and when required, synchronization between the map tile maker device 302 and the spatial data storage module 304 may take place.

In some embodiments, dependencies 308b, such as the Geospatial Data Abstraction Library (GDAL), may be used for reading and writing raster and vector geospatial data formats. The GDAL may include command line utilities for data translation and processing, such as, but not limited to: (a.) Reading and writing of raster and vector geospatial formats; (b.) Data format translation; (c.) Geospatial processing, for example: subsetting, image warping, reprojection, mosaicing, tiling, digital elevation model (DEM) processing.

The GDAL comprises various library methods that may be used to facilitate the tiling processing of the satellite imagery in Geotiff data format. An example of a library method is the gdal2tiles function, which is an extension plugin of GDAL that can generate tilesets and metadata from Geotiff files in compliance with a standard, such as the OSGeo™ Tile Map Service Specification. The generated tilesets can be used to display image overlays on various interactive web map platforms, such as, but not limited to, Leaflet™, Google Maps™, and OpenLayers™.

The compiled binary file based on gdal2tiles source code may include part of the static libraries for data raster tiling processing, and may further be cross-compiled for different operating systems via platform as a service (PaaS) or virtual machine technology.

The gdal2tiles function may support single threaded tiling and multi-threaded tiling processes. The multi-threading tiling process may be utilized in distributed and/or parallel processing systems where multiple instances of generating tiles from the spatial data file, for example using the method 100, are running in parallel.

The gdal2tiles may be configured to receive input parameters. The input parameters may include a resampling parameter; a conversion scheme or specified file format, for example TMS or XYZ Slippy Map standard; the zoom level to render; and number of processes to use for tiling and/or to speed-up computation.

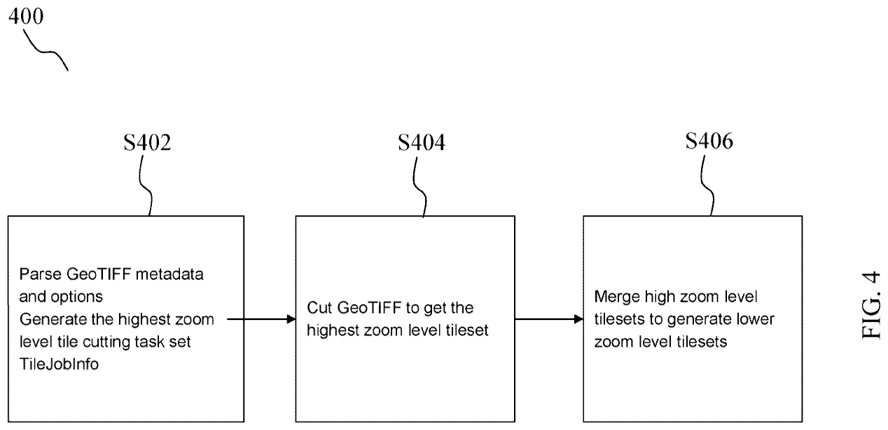

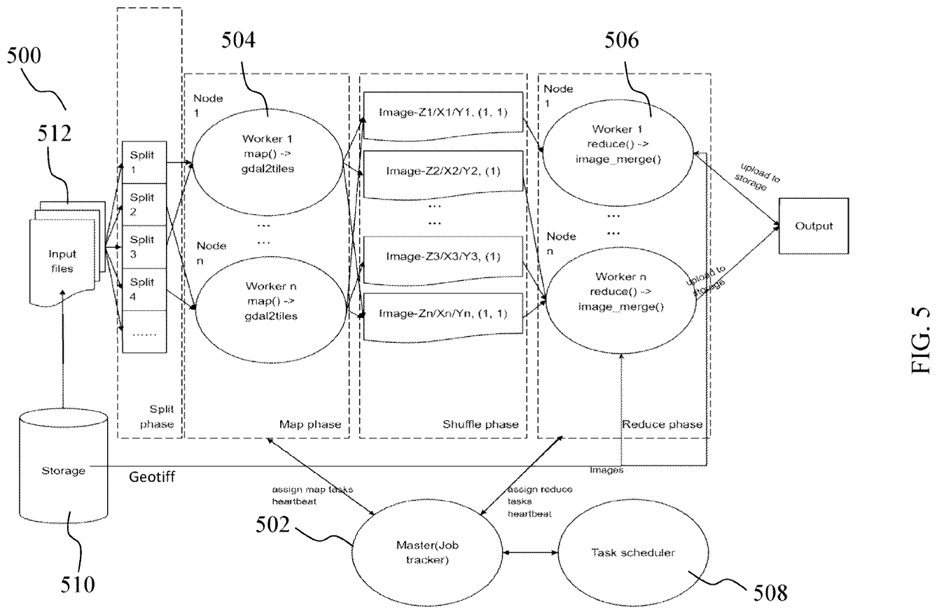

FIG. 4 shows one example of the gdal2tiles function to generate a plurality of tiles. The process 400 may include three steps as shown in FIG. 4.

At step S402, metadata of the Geotiff data may be parsed based on the input parameters selected, and the highest zoom level is calculated, assigned or derived based on the input parameter related to the zoom level to render. The highest zoom level is configured as part of the input of the class TileJobInfo of the gdal2tiles function.

At step S404: Based on the input of the TileJobInfo class, the spatial data tile Geotiff data is split or cut to obtain a tileset with the highest zoom level. The tilesets of lower zoom level may be generated from the tileset of the higher zoom level, which has faster generation speed. As the tilesets with the highest zoom level can only be obtained from Geotiff file using GDAL, their speed may be affected by the size of Geotiff file. In general, the lower the zoom level of the tileset obtained from Geotiff, the larger the geographical area obtained in a single cut, and the slower the speed of acquisition. For example, the time to generate a tile with zoom level 17 from Geotiff will be much longer than the time to get 4 tiles with zoom level 18 from Geotiff and merge them. As such, it is computationally more economic to generate tiles of higher zoom level and then derive the tile of a lower zoom level by merging 4 or more tiles.

At step S406: Create_overview_tiles function is used to generate low zoom level tilesets by merging high zoom level tilesets.

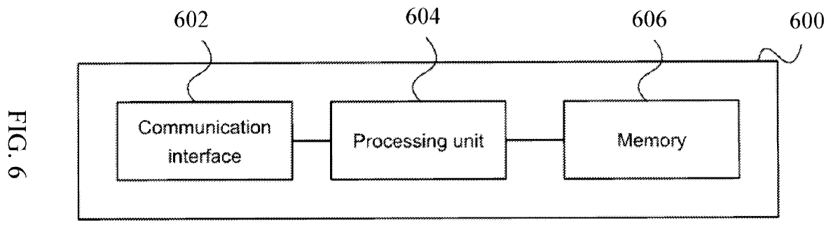

FIG. 5 shows a distributed system 500 for processing spatial data in accordance with various embodiments. The distributed system 500 may have a multi-node system architecture for processing and generating big data sets with a parallel, distributed algorithm on a cluster of servers. The distributed system 500 is suited for relatively fast processing of large number of spatial data, such as satellite imagery. An example of such a programming model is the “MapReduce™ System”, which facilitates the processing by running the various instances of the method 100 in parallel, managing all communications and data transfers between the various parts of the system 500, and providing for redundancy and fault tolerance.

The distributed system 500 may comprise a plurality of nodes configured to perform various tasks such as generating map tiles, comparing map tiles to detect one or more duplicates, and combining duplicated map tiles so as to achieve data compression and facilitate data update. At least one node may be configured to assign tasks to other nodes and to monitor the progress of the other nodes. As illustrated, the system may comprise a master node 502 and a plurality of worker nodes 504 associated with a first task and a plurality of worker nodes 506 associated with a second task. The master node 502 is arranged in data or signal communication with each worker node 504, 506. The master node 502 comprises a task monitor-also referred to as a job tracker. The job tracker is responsible for resource monitoring and job scheduling. The job tracker monitors the status of all worker nodes 504, 506 and the jobs or tasks carried out by each worker node 504, 506, and re-assigns jobs or tasks to other worker nodes 504, 506 in case of failure of one or more worker nodes 504, 506. The job tracker may also track the execution progress of tasks, resource usage and other information, and send such data to a task scheduler 508.

The task scheduler 508 may be a detachable module or a plug-in module. The task scheduler 508 may be implemented as a separate node from the master node 502. The task scheduler 508 can be configured according to the requirement(s) of a user. The scheduler 508 is configured to select a task to use the node resources when they become available.

Each worker node 504, 506 may be configured as a slave arranged in data or signal communication with the master node 502 to implement one or multiple instances of processing spatial data. In the embodiment illustrated in FIG. 5, a first set of n worker nodes 504 are configured to carry out the first task, i.e. steps associated with converting spatial data files into corresponding tiles and metadata (also referred to as a map task), and a second set of n worker nodes 506 are configured to carry out the second task, i.e. steps associated with merging duplicate tiles (also referred to as a reduce task).

The task scheduler 508 is arranged in data/signal communication with the master node 502, to receive node and task related information and schedule the tasks to the slave nodes 504, 506. The task scheduler 508 may be a dynamic task scheduler. Each task may be either a map task using a map function such as the gdal2tile function, or a reduce task. In some embodiments, a worker node may be responsible for executing both tasks. The worker node 504, 506 periodically reports any computer or memory resource usage and progress of ongoing task on its node to the master node 502 via one or more periodic signals, also referred to as heartbeat signals, and receives commands from the master node 502 to perform corresponding actions such as execute a new task, stop a current task, kill a current task, etc.

In operation, the master node 502, via the task scheduler 508, assigns one or more “slots” to each worker node 504, 506. A “slot” represents computational resources such as CPU resources in the form of computing power, memory resource in the form of RAM, ROM, etc. A task may be assigned a slot before it is executed, and the master node 502 is operable to allocate available for use by the worker node 504, 506. In some embodiments, two types of slots, a map slot and a reduce slot, which are used by the map task and reduce task respectively. The task scheduler 508 limits the concurrency of the task by the number of slots. The number of slots may be a customizable parameter or may be predefined by a user.

The system 500 is next described in the context of its operation, with reference to four phases-a split phase, a map phase, a shuffle phase and a reduce phase. The system 500 is particularly suited for processing relatively large number of spatial data files in a distributed and parallel architecture. The spatial data files may be in various data formats.

Split phase-In the split phase, spatial data files, which may be in the form of satellite imagery in different data format, are received from a source storage 510 in the form of a batch input files 512. The batch of spatial data files are splitted to obtain the corresponding individual spatial data input files. Each individual spatial data file size may not exceed a specific block size. The specific block size may be a configurable or pre-defined parameter.

In some embodiments, spatial data determined as a tile with accompanying metadata, such as a Geotiff tile with metadata, are treated as atomic files i.e., no split operation is performed on the input individual Geotiff tile. Such atomic file are sent directly to an assigned worker node 506 for the reduce task. Such a configuration may reduce the re-computation and splitting time for the image, geographic and metadata information of the Geotiff files.

Each generated split is assigned to one map worker 504 to generate a plurality of tiles.

Map phase-Using the assigned split Geotiff file as input, each worker node 504 is assigned to generate a plurality of tiles based on the method 400. The worker node 504 applies the method 400 to generate the files, and writes the generated output tiles to a temporary storage, which may be a cache. The master node 502 may be configured to determine that only one copy of an input spatial file is processed.

As the worker node 504 receives the split Geotiffs data and executes the map task to generate the plurality of tiles, the worker node 504 may periodically send a heartbeat signal to the master node 502 to indicate its progress. Once the worker node 504 completes the map task, it may send a heartbeat signal indicating it is in a ready state to execute a new task, and the master node 502 may assign the worker node 504 with a new map task.

In some embodiments, the map task may be assigned based on a scheduling logic, such as Data-Local, in which the map task may be assigned to the worker node 504 that contains the split data block required by the map task, and a split spatial data file (in the form of a map package) may be copied to the assigned worker node 504. The map package may be a custom map function that is used to process the data input to the map task, in this case by calling gdal2tiles for tiling processing Geotiff in parallel to generate a first tileset(s) comprising the image and corresponding metadata. In summary, the map phase is mainly responsible for the parallel tiling processing of the batch Geotiff satellite imagery to generate raster tilesets, which are regarded as intermediate tile files.

Shuffle phase—In the shuffle phase, a processor may be used to obtain the intermediate tile files from the worker nodes 504. Operations such as partitioning, sorting and combining are then carried out. Such operations are based on the parsing the metadata to generate relevant key in the form of Z/X/Y, where Z represents the zoom level, X and Y represent the X and Y coordinates of the image on the plane axis respectively. The partitioning operation may be performed according to different sharding logic, for example, key Z/X/Y hashcode % the number of the reduce workers, and store the intermediate tiles generated in the map phase in different partitions based on their keys. The sort operation of sorting the intermediate files for the key output of the map phase. The combine operation merges duplicate key values of the intermediate results generated by the map phase. The intermediate results refer to all images in the generated tileset from the map phase, with the key Z/X/Y. It is appreciable that each image has a unique Z/X/Y key and different satellite imagery tiles may generate the same Z/X/Y images in the tilesets. Therefore, the combine operation will record the merge operation for the duplicate key values from tilesets.

In some embodiments, the hash function may include any function(s) that can be used to correlate spatial map data of any size to a fixed size value. The final fixed size mapping result is expressed in the form of a hashcode. Different data can be processed by the hash function to generate a different hashcode. The hashcode obtained by the same hash method will be the same every time for the same data, so as to ensure consistency. The hashcode may be expressed in the form of a string data-type. In some embodiments, the hashcode can be divided by an integer and the remainder found (e.g. using the mathematical operation modulo). The integer may be the number of worker nodes 504, 506. By using the aforementioned string modulo method, the spatial data tiles may be evenly distributed to different workers depending on Z/X/Y.

For example, in an embodiment where there are two reduce workers 506 and four spatial data files Z1/X1/Y1, Z2/X2/Y2, Z3/X3/Y3, Z4/X4/Y4. Applying the same hash function or method,

Z1/X1/Y1 generates hashcode1 by hash method, hashcode1 string modulo 2=0.

Z2/X2/Y2 generates hashcode2 by the hash method, hashcode2 string modulo 2=1.

Z3/X3/Y3 generates hashcode3 by hash method, hashcode3 string modulo 2=1.

Z4/X4/Y4 generates hashcode4 by hash method, hashcode4 string modulo 2=0.

Then Z1/X1/Y1 and Z4/X4/Y4 will be processed by a first reduce worker 506, and Z2/X2/Y2 and Z3/X3/Y3 will be reduced by a second reduce worker 506.

If the tilesets generated by map worker 1 and map worker n both include Z1/X1/Y1 images, the combine operation will generate a duplicate indicator (1, 1) and record the duplicate image as Image-Z1/X1/Y1, (1, 1). As another example, if only the generated tilesets from map worker n includes Z3/X3/Y3 image, the combine operation will generate a duplicate indicator (1)—indicating no duplicate, and record the Image-Z3/X3/Y3, (1). In the aforementioned examples, (1, 1) means there are two images with this key in the generated tilesets, (1) means there is only one image with this key in the tilesets.

It is contemplated that the combine operation may achieve at least one of data aggregation, data race avoidance, consistency of data, and the idempotency of subsequent reduce phase to execute tasks.

In some embodiments, the images in the generated tilesets by the worker nodes 504 may be transferred over a remote network into or read directly from a local resource of the worker node 506 assigned to a reduce task according to the key Z/X/Y partitioning result. For example, image-Z2/X2/Y2, (1) generated by the map worker 504 of node 1 transferred to the reduce worker 506 of node n. In some embodiments, the key duplicate images may be transferred to or read locally by one reduce worker 506, for example, image-Z1/X1/Y1, (1,1) is read directly from local by reduce worker 1 of node 1 as input data for the reduce task.

Reduce phase—The reduce phase may use computational and storage resources by unified planning and scheduling of reduce tasks, and achieves the purpose of incrementally updating the generated tilesets to the existing tilesets in storage. The tasks of the reduce phase are also executed by a custom reduce package. In the reduce phase, the image corresponding to the key (Z/X/Y) is first determined whether to be in the storage, and if it exists, the image is downloaded by referencing the key in the storage to the node and merging the image with the images of the same key of the reduce task by calling image processing library's merge method, and finally upload the output image to the storage. If the image for the key (Z/X/Y) does not exist in storage, the images with the same key are first merged locally in the node (no need to merge if there is only one image for the key in the node), and then the resulting image is uploaded to storage. When all reduce tasks are finished, the whole system completes the distributed processing of the batch Geotiff satellite imagery data and the incremental update of the existing satellite tilesets.

FIG. 6 shows a server computer system 600 according to various embodiments. The server computer system 600 includes a communication interface 602 (e.g. configured to receive input data from the first sensors 104). The server computer 600 further includes a processing unit 604 and a memory 606. The memory 606 may be used by the processing unit 604 to store, for example, data to be processed, such as data associated with the input data and results output from the modules 202, 204, 206. The server computer is configured to perform the method of FIG. 1 and/or FIG. 4. It should be noted that the server computer system 600 can be a distributed system including a plurality of computers. The memory 606 may include a non-transitory computer readable medium.

In various embodiments where image processing steps are utilized, an image processing library, i.e. a free and open-source cross-platform software suite for displaying, creating, converting, modifying, and editing raster images may be used. In particular, the convert program in CLI may be used to convert between image formats as well as perform various image processing operations such as resize an image, blur, crop, despeckle, dither, draw on, flip, join, re-sample, and much more. In the various described embodiments, the image processing library may be utilized for overlaying and merging multiple images into a single image.

In the described embodiments, it is contemplated that a generated tileset or an updated tileset can be obtained by selecting output to a specified directory or packaged as a mbtile file format. MBTiles is a file format for storing raster or vector tilesets in an SQLite database.

It is contemplated that the output of the method, system and/or device as described may be deployed in a navigation system for access by a vehicle, such as a car. In particular, the generated updated map tiles may be assessed by a navigation system installed in the car with a user-interface, such as a touch screen, to render a map comprising the processed spatial data.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. A method for processing spatial data comprising the steps of:
receiving a spatial data file from a spatial data source;
generating a first tileset associated with the spatial data file, the first tileset comprising a plurality of tiles and corresponding identifiers;
comparing the identifier of each of the plurality of tiles in the first tileset with an identifier of each tile in a second tileset to identify at least one duplicate; and
merging the tiles identified to be duplicate tiles.

2. The method of claim 1, wherein each generated identifier comprises a zoom level data and a location data associated with the corresponding tile.

3. The method of claim 2, further comprising a step of generating a duplicate indicator and appending the duplicate indicator to the identifier, the duplicate indicator associated with the number of duplicate tiles in the first tileset and the second tileset.

4. The method of claim 1, wherein the step of generating the first tileset comprises combining a plurality of generated tiles associated with a higher zoom level to generate a tile associated with a lower zoom level.

5. The method of claim 1, further comprising a step of packaging the merged tiles into a file format for storing tileset.

6. The method of claim 1, wherein the merged tiles are stored in a specified directory.

7. The method of claim 1, wherein the step of merging the tiles comprises overlaying at least one duplicate tile over another duplicate tile.

8. A device for processing spatial data comprising
an input module configured to receive a spatial data file and a second tileset;
a tiling module configured to generate a first tileset associated with the spatial data file, the first tileset comprises a plurality of tiles and corresponding identifiers;
an update module configured to
compare the identifier of each of the plurality of tiles within the first tileset with an identifier of each tile in a second tileset to identify at least one duplicate; and merge the tiles identified to be duplicate tiles.

9. The device of claim 8, wherein each generated identifier comprises a zoom level data and a location data associated with the corresponding tile, wherein the update module is optionally configured to generate and append a duplicate indicator to the zoom level data and the location data, the duplicate indicator associated with the number of duplicate tiles in the first tileset and the second tileset.

10. The device of claim 8, wherein the tiling module is configured to generate the first tileset by combining a plurality of generated tiles associated with a higher zoom level to generate a tile associated with a lower zoom level.

11. The device of claim 8, wherein the update module is configured to package the merged tiles into a file format for storing tileset or configured to store the merged tiles into a specific directory, and/or wherein the update module is optionally configured to merge the duplicate tiles by overlaying at least one duplicate tile over another duplicate tile.

12. A system for processing spatial data comprising the device of claim 8, and a storage module, wherein the merged tiles are sent to the storage module.

13. The system of claim 12, further comprising a Web Map Tile Service (WMTS) service, wherein the storage module comprise an interface to allow access by a Web Map Tile Service (WMTS), wherein the system optionally comprise a vehicle navigation system configured to access the WMTS for rendering map tiles on demand.

14. A system for processing spatial data comprising
a master node arranged in data or signal communication with a plurality of slave nodes, the master node comprising a task scheduler to assign at least one task to each of the plurality of slave nodes;
a first slave node configured to generate a first tileset associated with a first spatial data file, the first tileset comprising a plurality of tiles and corresponding identifiers;
a second slave node configured to generate a second tileset associated with a second spatial data file, the first second tileset comprising a plurality of tiles and corresponding identifiers;
a processing module configured to compare the identifiers of each of the plurality of tiles within the first tileset with the identifiers of each tile in the second tileset to identify at least one duplicate, and
a third slave node configured to merge the tiles identified to be duplicated tiles.

15. The system of claim 14, wherein each generated identifier comprises a zoom level data and a location data associated with the corresponding tile, and wherein the update module is optionally configured to generate and append a duplicate indicator to the zoom level data and the location data, the duplicate indicator associated with the number of duplicate tiles in the first tileset and the second tileset.

16. The system of claim 14, further comprising a storage module arranged in data or signal communication with at least one of the first slave node, the second slave node and the third slave node, the system optionally comprise a pre-processing module to obtain a batch of spatial data and split the batch of spatial data into at least the first spatial data file and the second spatial data file.

17. The system of claim 16, wherein where the system comprise a pre-processing module, the storage module is configured to identify from the batch of spatial data, at least one spatial data file associated with a specific file format, such that spatial data files associated with the specific file format are configured to be sent to the third slave node bypassing the pre-processing module.

18. A non-transitory computer-readable storage medium comprising instructions, which, when executed by one or more processors, cause the execution of the method for processing spatial data according to claim 1.

19. A data processing device configured to perform the method of claim 1.

20. A computer executable code comprising instructions for processing spatial data according to claim 1.
